(19) United States
(12) Patent Application Publication
(10) Pub. No.: US 2001/0047276 A1
(43) Pub. Date: Nov. 29, 2001

(54) Business to business technology exchange and collaboration system and method

(76) Inventor: Fritz Eisenhart, San Francisco, CA (US)

Correspondence Address: MORGAN & FINNEGAN, L.L.P., 345 Park Avenue, New York, NY, 10154, US

(21) Appl. No.: 09/817,730

(22) Filed: Mar. 27, 2001

Related U.S. Application Data
(60) Provisional application No. 60/192,600, filed on Mar. 27, 2000.

(51) Int. Cl. G06F 17/60

(52) U.S. Cl. 705/1

(57) ABSTRACT

A method, system, and apparatus for technology exchange and collaboration on a computer network such as the Internet. A member is granted access to substantive content on the community web site after registering with the system and satisfying qualification criteria. Each community member is required to create a personal profile tailored to the role that the member serves in the community. If the member's role is that of a Supplier, the member creates a project profile for each technology innovation. The system facilitates collaboration between a technology Supplier and a Buyer of a technology asset or a Contributor to a technology project by comparing the member profiles to identify a member whose search requirements match another member's search requirements. When a member decides to exchange technology with a Supplier, he requests direct contact with the Supplier and negotiates technology transfer agreements that protect the intellectual property rights of both parties. The evaluation and collaboration development of the technology is performed in a secure area. The system also provides digital notarization and secure encryption to protect the exchange between the member and the Supplier.

CROSS-REFERENCE TO RELATED APPLICATIONS

The present application claims priority from, and incorporates by reference, the provisional application for letters patent, No. 60/192,600, filed in the U.S. patent and Trademark Office on Mar. 27, 2000.

### NOTICE OF MATERIAL SUBJECT TO COPYRIGHT PROTECTION

All of the material in the present application is subject to copyright protection under the copyright laws of the United States and of other countries. The owner of the copyright rights has no objection to the facsimile reproduction by anyone of the present application as it appears in the United States Patent and Trademark Office file or records, but otherwise reserves all copyright rights whatsoever.

### FIELD

A method, system, and apparatus for technology exchange and collaboration on a computer network such as the Internet. More particularly, a method, system, and apparatus that facilitates collaboration between a Supplier and a Buyer of technology or a Contributor to a technology project by providing a secure area to evaluate, fund, develop, transfer, and/or exchange the technology or project.

### BACKGROUND

Technological innovations occur internationally, and are developed in a variety of organizations. For example, large pharmaceutical and biotechnology companies are more aggressive in the development, funding, and commercialization of innovations, where smaller startup companies and university research facilities are more selective in the development and funding of technological innovations. Moreover, many of these small entities do not have the manpower or resources to successfully commercialize their innovations.

The dissemination and/or commercialization of an innovation can be an unwieldy and complicated process. Important players in the innovation chain are frequently uninformed of new products or intellectual capital. This information gap affects not only an originator of a technology (“Supplier”), but also anyone interested in funding, licensing, or purchasing the technology (“Buyer”) or contributing to the commercial development of the technology (“Contributor”).

Technology transfer offices at universities and for smaller private laboratories constantly are searching for funding for research and development projects and strive to promulgate the output of their technologists. To obtain the best financial results, a technology transfer officer attempts to reach as many potential out-licensing, financing, or purchasing partners as possible. This often proves to be a daunting challenge. The persons and organizations they endeavor to reach are a highly segregated and geographically diverse group. Financial, manpower, and time constraints limit the scope of the technology transfer officers' ability to reach potential partners. Maintaining an ongoing relationship with every potential partner is nearly impossible.

In the past, traditional technology brokers created a database of technology innovations and sold access to the database to potential Buyers of the technology. Venture capital organizations and technology incubators also acted as local concentration points for technology. Some current Internet-based solutions offer a listing approach or a post and browse approach to search for technology innovations. These approaches essentially support a one-way search process, not a bi-directional match process. The one-way search process does not guarantee that the found counterpart is interested in a transaction. While the traditional and Internet-based solutions reduce the search costs and increase the relevance of the search results, a need exists to match Supplier, Buyer, and/or Contributor technology transactions.

In view of these deficiencies, there is a need for a system that facilitates access to a global universe of technology assets and innovations, match a Buyer for a Supplier's technology or a Contributor interested in the Supplier's technology innovation, and provides a secure area to evaluate and develop the technology asset or innovation. A system that meets this need will benefit the Supplier, Buyer, and Contributor by streamlining preliminary technology screening, initial negotiation, collaboration, and contract management. The technology exchange and collaboration system disclosed herein addresses these needs.

### SUMMARY

A method, system, and apparatus for technology exchange and collaboration on a computer network, such as the Internet, facilitates collaboration between a technology Supplier and a Buyer of a technology asset or a Contributor to a technology project by providing a secure area to evaluate and develop the technology asset or project.

A web-based presentation interface on a pedestrian web site provides a potential member with general information concerning the system. The potential member can view public news feeds and articles, descriptions of partners, related hypertext links, and information about the hosting company. In addition, a potential member can browse a directory listing of member and project profiles, but only public information is visible from the pedestrian web site.

In one embodiment, a potential member submits registration data to the system at a web-based presentation interface on a pedestrian web site. The registration data includes company contact information, personal contact information, the role that the potential member performs, and requested login account information. The system verifies the registration data to qualify the potential member. If the potential member qualifies, the system creates an account and provides the account login information to the potential member by electronic mail over the Internet. When a registered member submits the account login information at a web-based presentation interface on the pedestrian web site, the member is granted access to a home page on the community web site.

Access to the substantive content available on the community web site requires each member to create a member profile. The member profile includes personal contact and company information, personal work history, preferences (e.g., personal, industry sector, and geographical preferences), and information tailored to the role that the member performs. If the member's role is that of a Supplier, the system also requires the Supplier to create a project profile describing each technology innovation. The project profile includes a project description, market analysis, sales and marketing strategy, products and services, a description of the management team, financial information, and preferred qualities for dealing with a Buyer or a Contributor.

From the community web site, the member can browse a directory listing of member and project profiles that include more information than was available from the pedestrian web site. To allow the system to recommend other members likely to be a good match for a technology exchange, the member must also complete a need profile. The need profile is tailored to the member's role and includes specific characteristics that the member is looking for in a business partner and whether the characteristic is required or optional. The system determines whether a potential business partner is a good match by comparing the member requirement from both the member's perspective and the potential business partner's perspective. Only when both perspectives agree is the match identified as a good match. The system prioritizes all of the identified good matches using the number of characteristics in common and whether the characteristic is required or optional. While evaluating the list of good matches, if the member determines that a match is of interest, the member can request direct contact with the business partner to advance the evaluation. In another embodiment, the system periodically examines the database of profiles and sends an alert message to the member when an interesting profile or event occurs in the system.

The personal contact and company information identifying the member is disclosed to a Supplier with the request for direct contact. If the Supplier evaluates the information and decides to enter into a business deal with the member, an affirmative response is sent to the member that discloses more detailed project information to the member. Following evaluation of the more detailed information, the member determines whether he wants to advance evaluation of the technology by requesting either a non-exclusive or exclusive review agreement. If the member desires a non-exclusive review agreement, the member and the Supplier accede to a standardized due diligence agreement followed-up, optionally, by a letter of intent. If the member desires an exclusive review agreement, the member and the Supplier accede to a standardized right of first refusal agreement followed-up, optionally, by a letter of intent. The member can optionally choose to associate digital notarization for each exchange with the Supplier to certify the exchange.

The member and the Supplier can decide to terminate their business dealing at any decision point in the aforementioned process. The member can also request a transaction with the Supplier at any decision point in the aforementioned process. If the member requests a transaction, the system facilitates the negotiation of the terms of the transaction with collaboration tools and a communication network.

### BRIEF DESCRIPTION OF THE DRAWINGS

The accompanying figures best illustrate the details of the technology exchange and collaboration system, both as to its structure and operation. Like reference numbers and designations in these figures refer to like elements.

FIG. 1 is a network diagram depicting an embodiment of the operating environment for a technology exchange system 110.

FIG. 2 depicts the network diagram of FIG. 1, in greater detail, illustrating an embodiment of the relationship between the operating environment and the elements that comprise the systems that access the technology exchange system 110.

FIG. 3 depicts the network diagram of FIG. 2, in greater detail, illustrating an embodiment of the relationship between the network environment and the elements that comprise the technology exchange system 110.

FIG. 4 depicts the network diagram of FIG. 3, in greater detail, illustrating an embodiment of the relationship between the network environment and the elements that comprise the collaboration manager 325.

FIG. 5 depicts the network diagram of FIG. 3, in greater detail, illustrating an embodiment of the relationship between the network environment and the elements that comprise the secure collaboration manager 331.

FIG. 6 is a functional block diagram of an embodiment of the technology exchange system 110 illustrating the configuration of the hardware and software components.

FIG. 7A is a flow diagram of an embodiment of a process that registers a potential member 305 with the technology exchange system 110.

FIG. 7B is a flow diagram of an embodiment of a process that creates a profile in the technology exchange system 110 for a member 306.

FIG. 7C is a flow diagram of an embodiment of a process that automates the evaluation of a project in the technology exchange system 110.

FIG. 7D is a flow diagram of an embodiment of a process that initiates direct contact between a member 306 and a Supplier by requesting a more thorough description of the project from the Supplier.

FIG. 7E is a flow diagram of an embodiment of a process that the member 306 and the Supplier use to enter into a due diligence agreement.

FIG. 7F is a flow diagram of an embodiment of a process that the member 306 and the Supplier use to enter into a right of first refusal agreement.

FIG. 7G is a flow diagram of an embodiment of a process that the member 306 and the Supplier use to execute a letter of intent.

### DETAILED DESCRIPTION

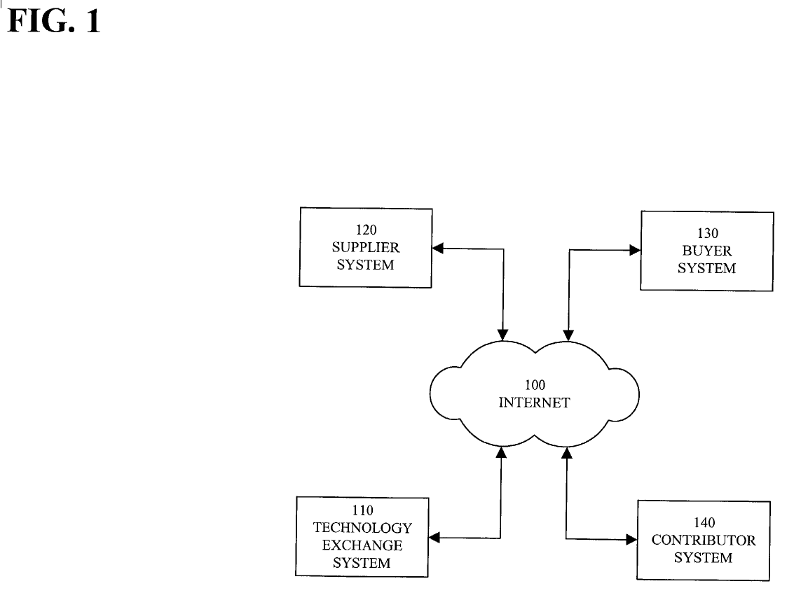

FIG. 1 depicts the operating environment for an embodiment of the method, system, and apparatus for technology exchange and collaboration. Internet 100, a public communication network, is the communication medium that allows technology exchange system 110 to communicate with Supplier system 120, Buyer system 130, and Contributor system 140. Even though the embodiment depicted in FIG. 1 uses Internet 100, the method, system, and apparatus for technology exchange and collaboration contemplates the use of other public or private network architectures such as an intranet or extranet. An intranet is a private communication network that functions similar to Internet 100. An organization such as a corporation creates an intranet to provide a secure means for members of the organization to access the resources on the organization's network. An extranet is also a private communication network that functions similar to Internet 100. In contrast to an intranet, an extranet provides a secure means for the organization to authorize non-members of the organization to access certain resources on the organization's network. The method, system, and apparatus for technology exchange and collaboration also contemplates using a network protocol such as Ethernet or Token Ring as well as proprietary network protocols.

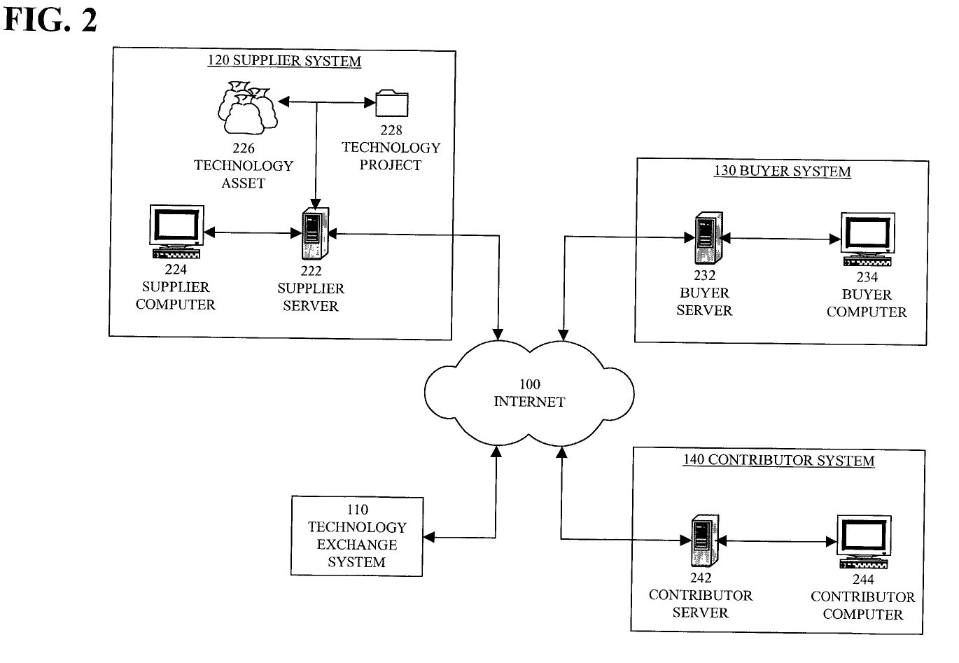

FIG. 2 expands the detail of technology exchange system 110 shown in FIG. 1 to illustrate the relationship between the operating environment and the elements that comprise Supplier system 120, Buyer system 130, and Contributor system 140. Technology exchange system 110 is a network-based computer program that functions as an integrated marketplace linking a Supplier of technology asset 226 or technology project 228 to a Buyer or Contributor engaged in the discovery, development, and commercialization of the technology. Technology exchange system 110 matches the Supplier's requirements with the Buyer's or Contributor's requirements to discover potential licensing, venture, and development opportunities for the Supplier.

Supplier system 120 comprises a Supplier server 222, Supplier computer 224, technology asset 226, and technology project 228. Supplier server 222 connects to Internet 100 and is accessible by a Supplier using Supplier computer 224. Supplier server 222 also provides the Supplier with access to technology asset 226 and technology project 228 as well as confidential data such as technical documents, test results, and empirical studies. In one embodiment, technology asset 226, technology project 228, and confidential data are only accessible through Supplier computer 224, not Internet 100. The Supplier uses Supplier computer 224 and the connection between Supplier server 222 and Internet 100 to register with and access technology exchange system 110.

Buyer system 130 comprises Buyer server 232, and Buyer computer 234. Buyer server 232 connects to Internet 100 and is accessible by a Buyer using Buyer computer 234. Buyer uses Buyer computer 234 and the connection between Buyer server 232 and Internet 100 to register with and access technology exchange system 110.

Contributor system 140 comprises Contributor server 242, and Contributor computer 244. Contributor server 242 connects to Internet 100 and is accessible by a Contributor using Contributor computer 244. The Contributor uses Contributor computer 244 and the connection between Contributor server 242 and Internet 100 to register with and access technology exchange system 110.

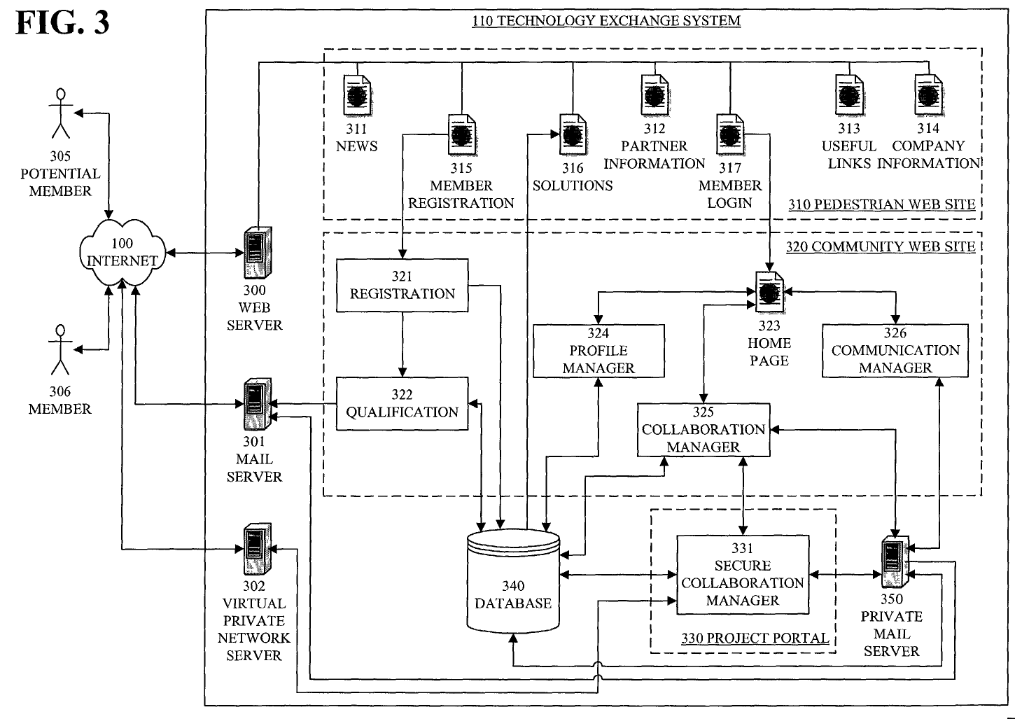

FIG. 3 expands the detail of FIG. 2 to illustrate the relationship between the network environment and the elements that comprise technology exchange system 110. Technology exchange system 110 includes web server 300, mail server 301, virtual private network server 302, database 340, and private mail server 350.

The implementation of web server 300 employs a tiered architecture of three web sites including pedestrian web site 310, community web site 320, and project portal 330. The tiered architecture grants access to some information, but restricts access to the next tier in the architecture. Thus, pedestrian web site 310 grants the general public access to free content and company information, but restricts access to community web site 320. Similarly, community web site 320 grants member 306 of the technology exchange and collaboration system access to non-confidential project information and collaboration tools, but restricts access to project portal 330. In one embodiment, the presentation interface for pedestrian web site 310, community web site 320, and project portal 330 is a web page based on the Hypertext Markup Language standard.

Mail server 301 is an electronic mail post office for technology exchange system 110 that sends and receives messages via Internet 100. An embodiment of the mail server 301 uses the Simple Mail Transfer Protocol (“SMTP”) to send a message and the Post Office Protocol version 3 (“POP3”) to receive a message. Other embodiments contemplate the use of other electronic mail architectures and transfer protocols.

Virtual private network server 302 implements a tunneling protocol and security procedures that provide technology exchange system 110 with a private data network that uses Internet 100. Virtual private network server 302 encrypts data before sending it through Internet 100 and decrypts it at the receiving end. An embodiment of virtual private network server 302 uses the Point-to-Point Tunneling Protocol (“PPTP”).

An embodiment of database 340 uses a relational database management system, such as the Postgres relational database or the Oracle8i relational database management system by Oracle Corporation, to create and manage the database and partitions. The technology exchange and collaboration system also contemplates the use of other database architectures such as an object-oriented database management system.

Private mail server 350 is an electronic mail post office for technology exchange system 110 that sends and receives messages via community web site 320 and project portal 330. Private mail server 350 stores the electronic mail messages in database 340 and uses a connection to mail server 301 to forward electronic mail messages received by the private mail server 350 to member 306 via Internet 100. Private mail server 350 does not have a direct connection to Internet 100. An embodiment of the private mail server 350 uses SMTP to send a message and POP3 to receive a message. Other embodiments contemplate the use of other electronic mail architectures and transfer protocols. Pedestrian web site 310 includes a section for news 311, partner information 312, useful links 313, and company information 314. News section 311 includes public press releases and electronic information feeds concerning upcoming events and published articles that relate to the technology exchange and collaboration system. The partner information section 312 includes a description of strategic, industry, technology, and content partners related to the technology exchange and collaboration system. The useful links section 313 includes hypertext links to related web pages such as a demonstration of the technology exchange and collaboration system. The company information section 314 includes an overview of the company hosting the technology exchange and collaboration system and a description of their business solutions as well as answers to the most frequently asked questions. Pedestrian web site 310 further includes a section for member registration 315, solutions 316, and member login 317 that restricts public access to community web site 320. Potential member 305 uses member registration section 315 of pedestrian web site 310 to request a member account that will facilitate access to community web site 320. Member 306 uses member login section 317 to access community web site 320. The solutions section 316 makes public information in community web site 320 available to a potential member 305.

Community web site 320 provides access to a secure area that allows member 306 to exchange non-confidential information that concerns technology asset 226 or technology project 228 with other community members. The exchange between the members is secure for two reasons. First, every data communication between member 306 and web server 300 is encrypted using the Internet secure sockets layer (“SSL”) protocol to protect against interception of the data stream. In addition, each member 306 uses an alias, or nickname, while accessing community web site 320 to guard against associating accidentally disclosed confidential information with the true identity of member 306.

Community web site 320 comprises registration component 321, qualification component 322, home page 323, profile manager 324, collaboration manager 325, and communication manager 326. Member registration section 315 of pedestrian web site 310 coordinates the interface to registration component 321 that restricts access to the qualification component 322.

The solutions section 316 of pedestrian web site 310 is an interface to database 340 that displays public information in the member and project profiles to a potential member 305. The public information includes the project title, description, mechanism of action for the technology, and the relevant industry sector. Member login section 317 of pedestrian web site 310 facilitates access to home page 323 or presentation interface for profile manager 324, collaboration manager 325, and communication manager 326.

Registration component 321 accepts identification information from potential member 305, and stores the identification information in database 340. Registration component 321 then signals qualification component 322 to determine whether potential member 305 qualifies as member 306. The process to qualify potential member 305 includes verifying the contact information for potential member 305 or completing a financial transaction. The entire qualification process should take place within three working days after potential member 305 enters the identification information. Once qualified, member 306 may access member login section 317 to access to home page 323 on community web site 320.

Member 306 accesses profile manager 324 from home page 323 to create and update a personal profile tailored to the member 306 role as well as a technology profile for each technology asset 226 or technology project 228 and a need profile. Member 306 can serve the role of either a Supplier of a technology innovation, a Buyer of the technology, or a Contributor to the technology. Since the technology exchange and collaboration system allows member 306 to have more than one role, each member 306 may create a separate profile for each role, however, only one role is active when member 306 is logged in to community web site 320. The member 306 workspace and functionality is dynamically set based on the currently active role. In one embodiment, member 306 uses a “switch role” feature on home page 323 to cause the entire workspace to be customized to the newly selected role. The profile includes non-confidential and confidential information as well as a set of requirements tailored to each role that the technology exchange and collaboration system uses to match a Supplier to either a Buyer or a Contributor. Profile manager component 324 provides additional presentation interfaces to allow member 306 to create and store a profile in database 340, or retrieve a profile from database 340 and update the information.

Optionally, member 306 can access collaboration manager 325 from home page 323. Collaboration manager 325 provides member 306 with a presentation interface for browsing a catalog of technology innovations available for exchange, determining the technology innovations that match the active profile, and requesting direct contact with a Supplier of the technology innovation. When the Supplier and member 306 agree to direct contact, collaboration manager 325 grants member 306 and the Supplier access to a secure area in project portal 330.

As an additional option, member 306 can access communication manager 326 from home page 323 to send or receive electronic mail messages, manage business contacts or a “To Do” list, or post a need for a particular technology innovation. Since communication manager 326 does not have a connection to Internet 100, member 306 cannot communicate with anyone outside the community.

Project portal 330 comprises secure collaboration manager 331. Once a Supplier and member 306 agree to direct contact in community web site 320, secure collaboration manager 331 guarantees that any information exchanged is not disclosed to any other community member. Secure collaboration manager 331 creates a secure area in the database 340 for the Supplier and member 306 under agreement, and provides several presentation interfaces and collaborative tools that store and retrieve information from the secure area. In another embodiment, secure collaboration manager 331 creates a direct connection between the Supplier and member 306 through virtual private network server 302.

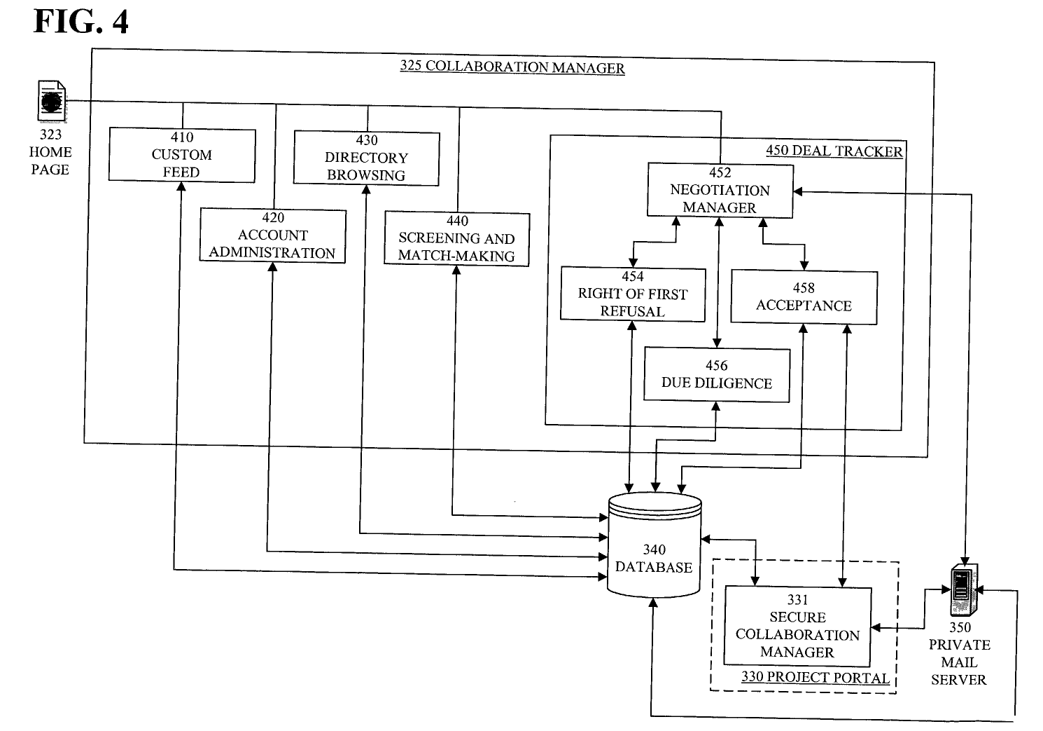

FIG. 4 further expands the detail of technology exchange system 110 to depict the logical components comprising collaboration manager 325 shown in FIG. 3. FIG. 4 also depicts the relationship between the network environment and those logical components.

Collaboration manager 325 includes custom feed 410, account administration component 420, directory browsing component 430, screening and match-making component 440, and deal tracker component 450.

Custom feed 410 gathers the latest industry headlines, news feeds, and resources from external content providers as well as editorial content, information about industry events and resources of interest to the member community. Custom feed 410 is similar to news feed 311, but retrieves additional confidential information. In one embodiment, the presentation interface for custom feed 410 displays data gathered from syndicated news channel by compiling aggregate content from various content providers that use an electronic data exchange standard such as Extensible Markup Language (“XML”) tags. Additional content providers offer direct links to their own channels of information that are directly integrated into custom feed 410. Also, since member 306 can host, moderate, and manage a content management service within community web site 320, another presentation interface for custom feed 410 presentation interface displays data gathered from these community content management services. Finally, since member 306 can compile a collection of resources (e.g., editorial content, templates, tools, useful links, discussion forums, promotional offers, etc.) into a digital library organized by topic, another presentation interface for custom feed 410 displays the content of these resources. Assuming, however, that the community member who places a resource in the digital library also provides member 306 accessing custom feed 410 access to the resource.

The account administration component 420 allows member 306 to manage their community web site 320 login account. Member 306 can check on a subscription status, secure collaboration area purchase, and similar information. Member 306 can also manage similar characteristics for a collection of community web site 320 accounts such as a company.

Directory browsing component 430 provides member 306 profile listings using the anonymous data in the personal profiles to list qualified Buyers (e.g., Financial Investors, Business Development, and Licensing Executives) and expertise Contributors (e.g., Subject Matter Experts, and Business Professionals) in a given technology. Directory browsing component 430 is similar to the solutions section 316 of pedestrian web site 310, but includes additional detail in the listing such as a full description, project stage, and keywords. Member 306 profile listings include a Financial Investor Directory organized by the type of investor (e.g., Venture Capitalist or Business Angel) or stage and range of investment; a Business Development and Licensing Directory organized by the type of deal sought or the targeted industry segment; and an Expertise Contributor Directory organized by the type of services offered and the payment options. In addition, directory browsing component 430 provides advanced search criteria and refined search term interface, links to the member profile, and listings that display the most recently created member 306 profile.

Directory browsing component 430 also provides technology profile listings using the non-confidential data in the technology profiles to list technology ventures, for development, acquisition, or in-licensing, from member 306 such as a company, academic and research institute, or industrial consortium. The technology profile listings include Technology Transfer Opportunities organized by the type of technology that a Supplier is offering for acquisition or licensing; Venture Development Opportunities organized by the type of funding sought, the management team, or the technology; and Technology Development Opportunities organized by the type of partnership and expertise sought. In addition, directory browsing component 430 provides advanced search criteria and refined search term interface, keyword classification, links to the technology profile, and listings that display the most recently created technology profile.

Screening and match-making component 440 compares the member 306 profile to the other profiles in the community using a dual or bi-directional matching algorithm to determine which community members or projects are likely to be a good match. Each member 306 completes a detailed personal profile that is tailored to the active role for member 306 (i.e., Buyer, Supplier, or Contributor). The profile is the mechanism that a Buyer or Contributor uses to express their technology interests and describe their technology competencies.

In addition to their personal profiles, each Supplier also completes a project profile for each technology asset 226 or technology project 228. A structured, user-friendly, self-guiding form system is provided to capture a comprehensive description of the technology innovation, the development status of the technology innovation, and the Supplier's preferred strategy going forward. Over time, the Supplier can update their project profiles, thereby remaining open to either a Buyer or Contributor seeking to participate in a technology project when it is in a later stage of development.

The form system for the project profiles is structured in a “business plan” type of format with sections such as product description, market and commercial description, funding, etc. In each section there are specific questions with multiple choices answers. Additional free text fields may be used for further comments and input of key words.

A similar approach is used for Buyers and Contributors interest profiles. This establishes the basis for a “common language” between the different parties where the selected answers on one side can be matched with the interests and preferences of a counterpart.

Once member 306 has completed a personal and need profile, the screening and match-making component 440 can determine which members and projects are likely to be a good match. The result of the matching process is a listing of all counterparts (if you are a Supplier than the counterparts are Buyers and Contributors; if you are a Buyer or a Contributor, the counterpart is a Supplier) that both match the need profile and project or member profiles.

Screening and match-making component 440 assists community members at every stage of the business development lifecycle by simplifying the screening and match-making process that characterizes today's marketplace. Screening and match-making component 440 requires the parties to distinguish between “Must Have” and “Nice to Have” selection criteria. Using these criteria, screening and match-making component 440 can evaluate the quality of the match using a “scorecard” that details the relevancy of the match for each criteria. Thus, when screening and match-making component 440 establishes a match, the process guarantees not only that both parties' selection criteria have been met, but also that both parties are aware of the quality and relevance of the match from the other's perspective. The presentation interface included in screening and match-making component 440 organizes the results into a list of matches that have occurred over a recent specified period, an archive of all matched results over time, and matched results that have become more or less relevant.

A Supplier can create a profile for each technology project it posts to the platform and for tracking all Buyers and Contributors matching its strategic needs as set forth in the project profile. A Buyer or Contributor can establish an unlimited number of portfolios that will automatically identify and track all projects meeting their respective selection criteria. This allows a Buyer to identify a Supplier at an earlier stage than the “preferred” stage of interest and track the progress of new emerging technologies and contact the owners.

Deal tracker component 450 further includes negotiation manager 452, right of first refusal component 454, due diligence component 456, and acceptance component 458. The negotiation manager 452 facilitates the initial direct contact between a Supplier of a technology and a Buyer or a Contributor interested in the technology. During the screening and matchmaking 440 process, the parties only disclose non-confidential information. In fact, confidential information is only disclosed when the parties agree to deal with each other and the disclosure can only take place in the secure workspace managed by secure collaboration manager 331.

Negotiation manager 452 provides standard templates to coordinate the negotiation of an agreement between a Supplier and either a Buyer or a Contributor. After the parties reach an agreement, they can disclose confidential information concerning the technology and collaborate in the development of the technology. As a first step, the Buyer or Contributor use a standard request template to send a request for an initial direct contact to the Supplier. This is accomplished by clicking on a single hypertext link associated with the Supplier on the presentation interface. The request discloses the requesting party's true identity to the Supplier so that the Supplier can decide whether a conflict prevents the Supplier from dealing with the requestor. If a conflict exists, the Supplier uses a standard response template to indicate that they decline to deal with the requestor. If a conflict does not exist, the Supplier uses a standard response template to indicate the requirements (e.g., restrictions on the use of the technology, or the type of Confidentiality Agreement required) that the requestor must meet before the Supplier will agree to direct contact. The Supplier decides whether to allow the requestor to enter the Supplier's secure collaboration area for the technology.

Negotiation manager 452 also provides standard templates for monitoring the progress of a request for direct contact. The templates are tailored to the active role for member 306. If the active role is that of a Contributor, negotiation manager 452 monitor templates include:

A listing of every deal (active and complete) that has involved the Contributor;

An active project listing of every project that secure collaboration manager 331 is coordinating for the Contributor; and

A status listing for all pending requests by the Contributor for direct contact with a Supplier.

If the active role is that of a Buyer, negotiation manager 452 monitor templates include:

A listing of every deal (active and complete) that has involved the Buyer;

An active project listing of every project that secure collaboration manager 331 is coordinating for the Buyer;

A status listing of all pending requests by the Buyer for direct contact with a Supplier;

A listing of every project involving the Buyer that is in the due diligence stage;

A listing of every project involving the Buyer that is in the negotiations stage; and

A listing of every project involving the Buyer that has involved the Supplier requesting to enter into a formal due diligence process.

If the active role is that of a Supplier, negotiation manager 452 monitor templates include:

A listing of every deal (active and complete) that has involved the Supplier;

An active project listing of every project that secure collaboration manager 331 is coordinating for the Supplier;

A status listing of all pending requests by the Supplier for direct contact with the Buyer or Contributor;

A listing of every project involving the Supplier that is in the due diligence stage;

A listing of every project involving the Supplier that is in the negotiations stage; and

A listing of every project involving the Supplier that the Buyer has requested to enter into a formal due diligence process.

Right of first refusal component 454 provides a Buyer with a standardized legal document for entering into an agreement with a Supplier. As part of the agreement, the Buyer is granted the right to undertake an exclusive review of the Supplier's technology asset 226 or technology project 228 for a given period of time in exchange for an amount of money to be agreed upon by both parties. The effect of this agreement is to “freeze” the Supplier's project and guarantee that no other Buyer is able to access the project even though the Supplier can still receive requests for direct contact. Potential Buyers and Contributors that are already in the secure collaboration area are put in a waiting mode until the option time is expired.

Digital notarization has also been included in secure collaboration manager 331 to allow a Supplier to digitally notarize key documents stored in secure collaboration manager 331. Digital notarization certifies and timestamps the contents of a document. As part of the secure collaboration manager 331 service, when selecting the right of first refusal component 454 the technology exchange and collaboration system will automatically notarize all documents related to the project at no additional cost until an agreement on the option is reached.

The due diligence component 456 includes a digital notary service in the workflow process. As soon as member 306 launches a due diligence request, whether it is exclusive or non-exclusive, every exchange of electronic mail messages and legal documents, such as a letter of intent, between the Buyer and the Supplier is automatically digitally notarized and stored.

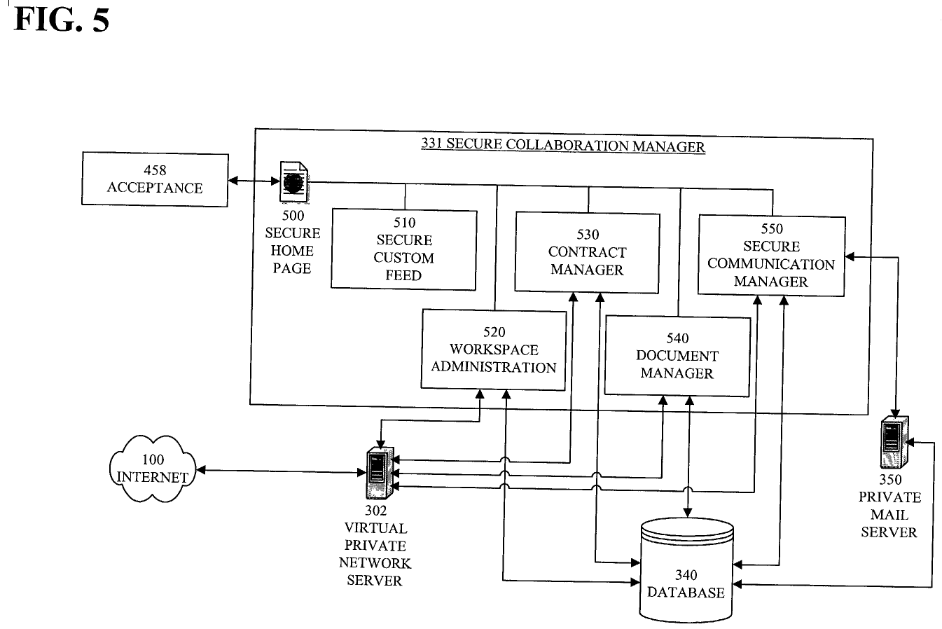

When a Supplier and either a Buyer or a Contributor reach an agreement during the course of the negotiation, acceptance component 458 facilitates the access by each party to secure collaboration area. FIG. 5 further expands the detail of the technology exchange system 110 to depict the logical components comprising the elements of secure collaboration manager 331 shown in FIG. 3. FIG. 5 also depicts the relationships between the network environment and those logical components. Secure collaboration manager 331 coordinates the functions performed by in a secure collaboration area that includes comprehensive project, business, and relationship management tools that facilitate information exchanges, transaction negotiations, and other critical business development processes. The secure collaboration area is an essential purchase for a Supplier of a technology, however a Buyer may also purchase a secure collaboration area for syndication purposes. The parties under agreement can use the Supplier's private and secure collaboration area as a virtual office for sharing documents, running discussion threads, and interacting with the parties involved in the collaborative project.

Secure collaboration manager 331 includes secure home page 500, that is the presentation for secure custom feed component 510, workspace administration component 520, contract manager 530, document manager 540, and secure communication manager 550. In one embodiment, the implementation of secure home page 500 is a web page based on the Hypertext Markup Language standard.

Secure custom feed component 510 gathers the latest industry headlines, news feeds, and resources from external content providers as well as editorial content, information about industry events and resources of interest to member 306 and the supplier in the secure collaboration area. Secure custom feed component 510 is similar to custom feed component 410 and news feed 311, but retrieve additional confidential information.

Workspace administration component 520 allows the owner of the secure collaboration area to maintain project portal 330. The owner can maintain secure home page 500, project address book, and access control list for the secure login account.

Contract manager 530 provides templates for legal documents that collaborating parties need to exchange. The templates include a request/response for initial direct contact, nondisclosure agreement (including both one-way and bi-directional disclosures), letter of intent to contract, due diligence agreement, and right of first refusal agreement.

Document manager 540 provides a virtual workspace for collaborating parties to share project related documentation. In addition, contract manager 540 includes access to multimedia tools to exchange video and audio files. Document manager 540 is integrated with the digital notarization service to protect the confidentiality of the information in a document by associating a fingerprint with the document.

Secure communication manager 550 is similar to communication manager 326 in community web site 320, but serves the parties under agreement in the secure collaboration area. Secure communication manager 550 allows one of the parties under agreement to send or receive an electronic mail message to the other party. Since secure communication manager 550 does not have a connection to Internet 100 or community web site 320, the parties under agreement cannot send or receive electronic mail messages to anyone outside member 306 community.

In another embodiment, the workspace administration component 520, contract manager 530, document manager 540, and secure communication manager 550 can create a direct connection between the Supplier and member 306 using virtual private network server 302. If member 306 chooses this option, the secure area resides on the Supplier's computer, not database 340.

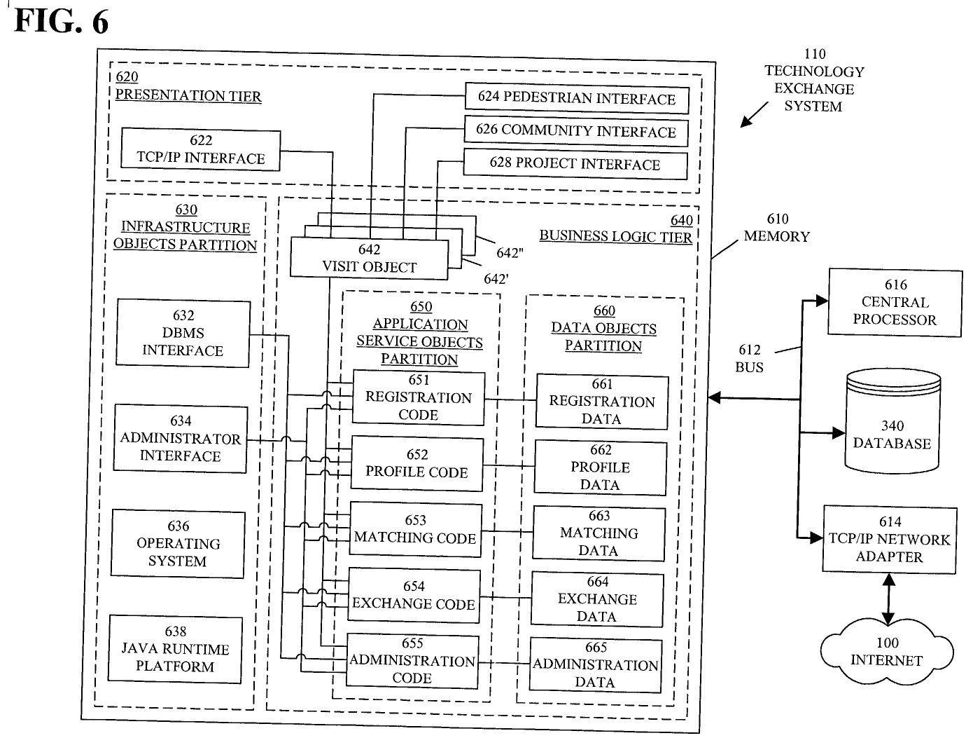

FIG. 6 is a functional block diagram showing the hardware and software components that comprise technology exchange system 110. Memory 610 of technology exchange system 110 stores the software components, in accordance with the technology exchange and collaboration system, that use Internet 100 to match a technology Supplier's requirements with a Buyer's or Contributor's requirements, facilitate collaboration between the parties, and discover potential licensing, venture, and development opportunities for the Supplier. System bus 612 connects memory 610 of technology exchange system 110 to transmission control protocol/internet protocol (“TCP/IP”) network adapter 614, database 340, and central processor 616. TCP/IP network adapter 614 is the mechanism that facilitates the passage of network traffic between technology exchange system 110 and Internet 100. Central processor 616 executes the programmed instructions or code stored in memory 610.

FIG. 6 shows the functional components of technology exchange system 110 arranged as an object model. The object model groups the object-oriented software programs into components that perform the major functions and applications in technology exchange system 110. A suitable implementation of the object-oriented software program components of FIG. 6 may use the Enterprise JavaBeans specification. The book by Paul J. Perrone et al., entitled “Building Java Enterprise Systems with J2EE” (Sams Publishing, June 2000) provides a description of a Java enterprise application developed using the Enterprise JavaBeans specification. The book by Matthew Reynolds, entitled “Beginning E-Commerce” (Wrox Press Inc., 2000) provides a description of the use of an object model in the design of a Web server for an Electronic Commerce application. The object model for memory 610 of technology exchange system 110 employs a three-tier architecture that includes presentation tier 620, infrastructure objects partition 630, and business logic tier 640. The object model further divides business logic tier 640 into two partitions, application service objects partition 650 and data objects partition 660.

Presentation tier 620 retains the programs that manage the graphical user interface to technology exchange system 110 for potential member 305 and member 306. In FIG. 6, presentation tier 620 includes TCP/IP interface 622, pedestrian interface 624, community interface 626, and project interface 628. A suitable implementation of presentation tier 620 may use Java servlets to interact with potential member 305 and member 306 of the technology exchange and collaboration system via the hypertext transfer protocol (“HTTP”). The Java servlets run within a request/response server that handles request messages from potential member 305 and member 306 and returns response messages to potential member 305 and member 306. A Java servlet is a Java program that runs within a Web server environment. A Java servlet takes a request as input, parses the data, performs logic operations, and issues a response back to potential member 305 and member 306. The Java runtime platform pools the Java servlets to simultaneously service many requests. A TCP/IP interface 622 that uses Java servlets functions as a Web server that communicates with potential member 305 and member 306 using the HTTP protocol. TCP/IP interface 622 accepts HTTP requests from potential member 305 and member 306 and passes the information in the request to visit object 642 in business logic tier 640. Visit object 642 passes result information returned from business logic tier 640 to TCP/IP interface 622. TCP/IP interface 622 sends these results back to potential member 305 and member 306 in an HTTP response. TCP/IP interface 622 uses TCP/IP network adapter 614 to exchange data via Internet 100.

Infrastructure objects partition 630 retains the programs that perform administrative and system functions on behalf of business logic tier 640. Infrastructure objects partition 630 includes operating system 636, and an object oriented software program component for database management system (“DBMS”) interface 632, system administrator interface 634, and Java runtime platform 638.

Business logic tier 640 retains the programs that perform the substance of the technology exchange and collaboration system. Business logic tier 640 in FIG. 6 includes multiple instances of visit object 642. A separate instance of visit object 642 exists for each client session initiated by either pedestrian interface 624, community interface 626, or project interface 628 via TCP/IP interface 622. Each visit object 642 is a stateful session bean that includes a persistent storage area from initiation through termination of the client session, not just during a single interaction or method call. The persistent storage area retains information associated with either potential member 305 or member 306. In addition, the persistent storage area retains data exchanged between technology exchange system 110 and Supplier system 120, Buyer system 130, or the Contributor system 140 via TCP/IP interface 622 such as the query result sets from a query to database 340.

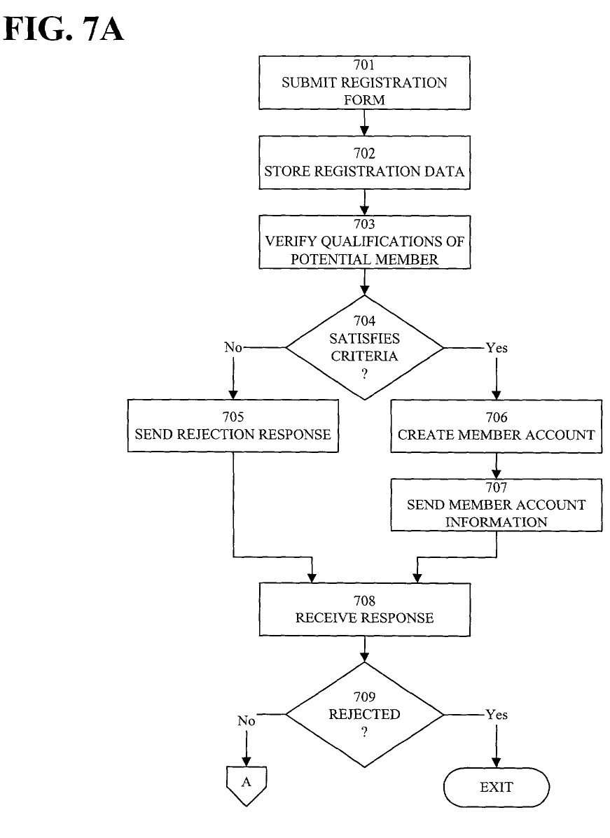

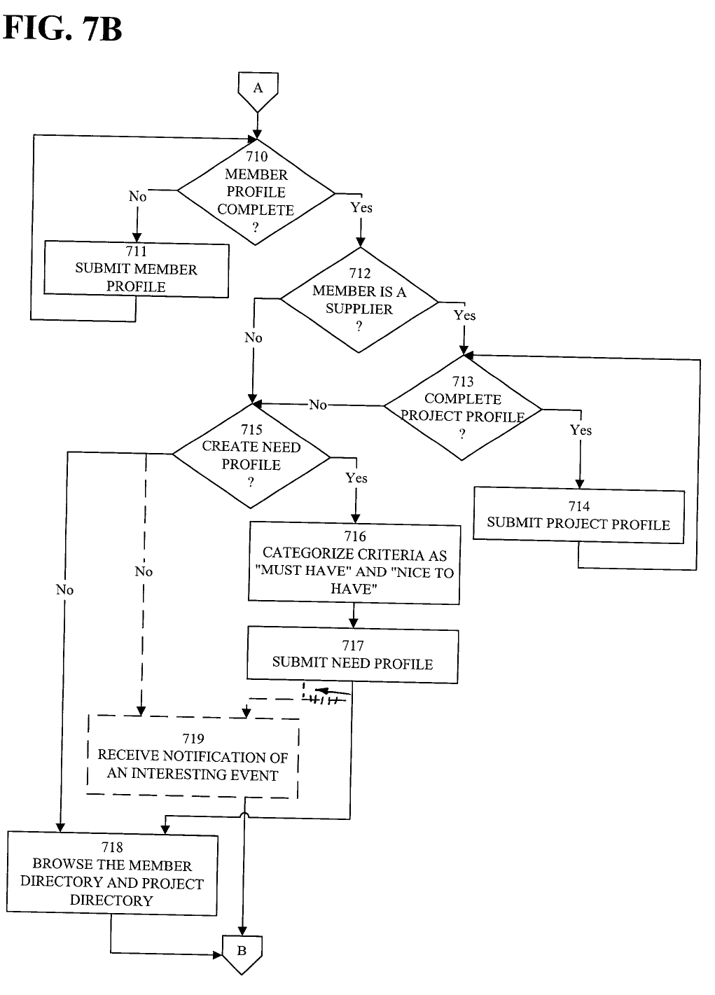

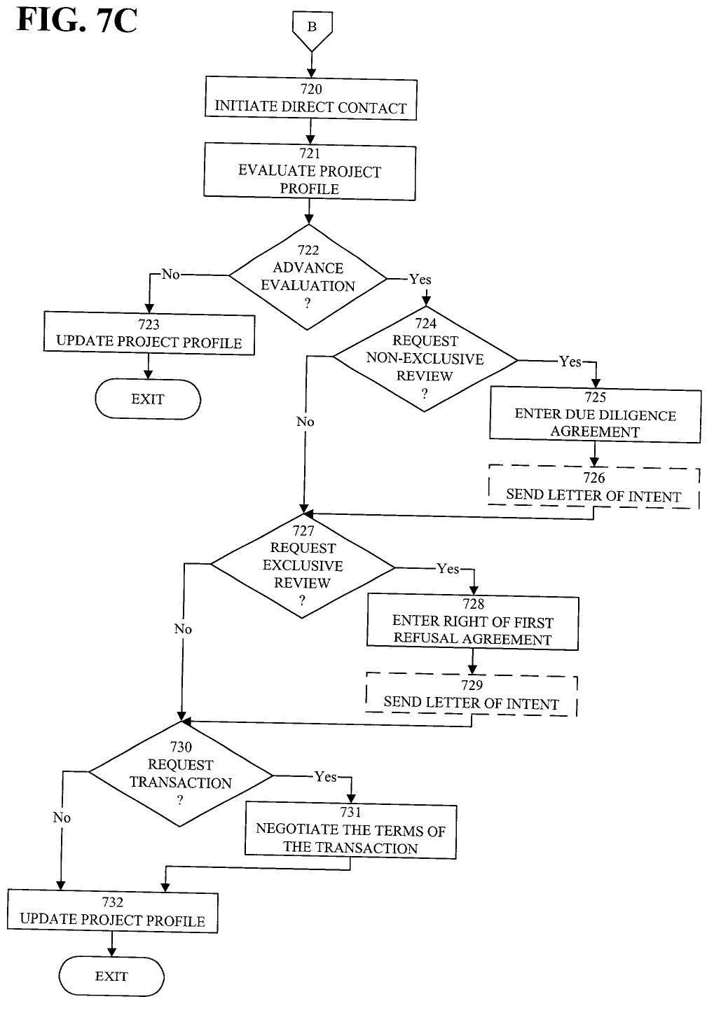

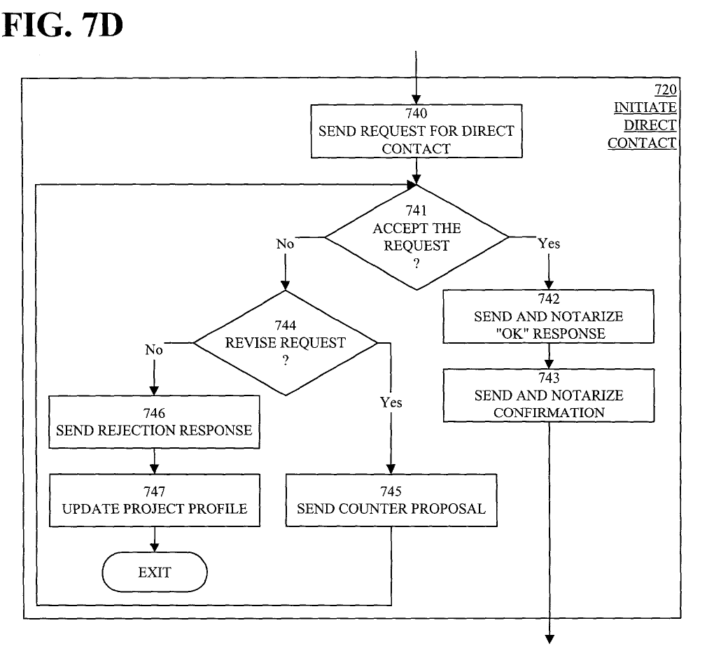

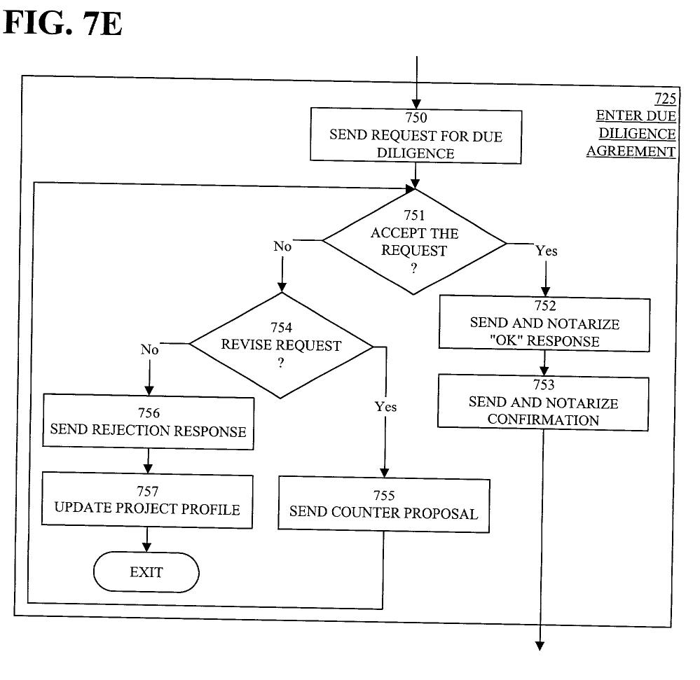

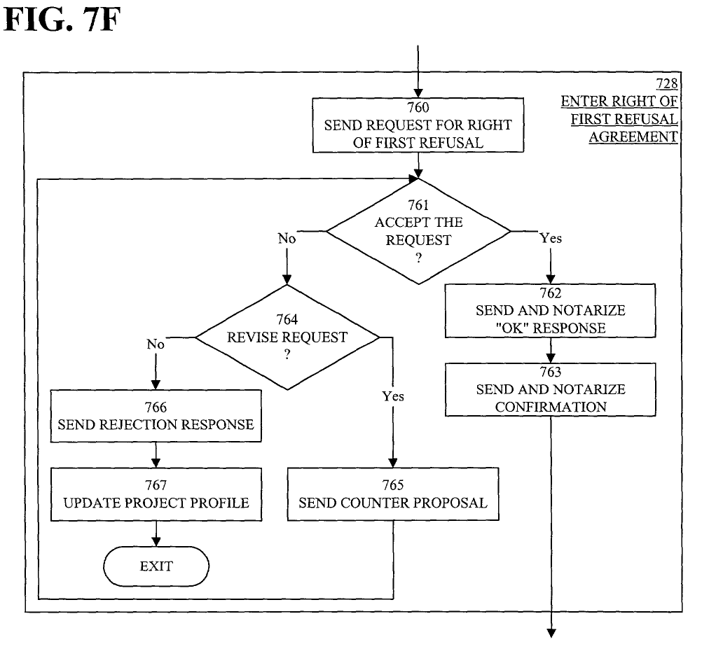

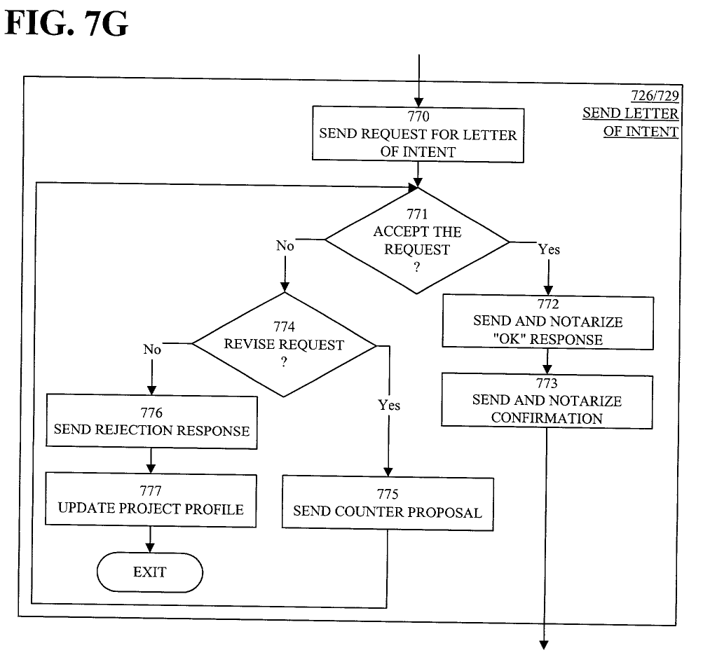

When potential member 305 accesses member registration 315 section of pedestrian web site 310, a message is sent to TCP/IP interface 622 to invoke a method that creates visit object 642 and stores connection information in visit object state 642. Visit object 642, in turn, invokes a method in registration code 651 to retrieve the data input by potential member 305 into pedestrian web site 310. Registration code 651 stores the data retrieved from pedestrian web site 310 in registration data state 661 and database 340. When potential member 305 completes the registration process, registration code 651 remains resident in memory 610 to coordinate the qualification of potential member 305. When registration code 651 receives an indication that potential member 305 qualifies, registration code 651 creates an electronic mail message addressed to potential member 305 and delivers the electronic mail message to mail server 301. FIG. 7A describes, in greater detail, the process that registration code 651 follows to register potential member 305 with technology exchange system 110. Even though FIG. 6 depicts central processor 616 as controlling registration code 651, it is to be understood that the function performed by registration code 651 can be distributed to a separate system configured similarly to technology exchange system 110.

When member 306 accesses member login section 316 of pedestrian web site 310, home page 323 sends a message to TCP/IP interface 622 to invoke a method that creates visit object 642 and stores connection information in visit object state 642. If member 306 has not created a personal profile, visit object 642 invokes a method in profile code 652 to retrieve personal profile data from member 306. Once member 306 creates a personal profile, visit object 642 invokes a method in profile code 652 to allow member 306 to edit the personal profile or create additional project profiles if the active role for member 306 is that of a Supplier. Member 306 then has the option to complete and submit a need profile that includes mandatory as well as custom match criteria categorized as either “must have” or “nice to have” or browse through the member or project directory for interesting technology. Profile code 652 stores the data retrieved from member 306 in profile data state 662 and database 340. FIG. 7B describes, in greater detail, the process that profile code 652 follows to maintain the profiles for member 306 and manage the search for interesting technology by member 306. Even though FIG. 6 depicts central processor 616 as controlling profile code 652, it is to be understood that the function performed by profile code 652 can be distributed to a separate system configured similarly to technology exchange system 110.

When member 306 is interested in a technology, home page 323 sends a message to TCP/IP interface 622 to invoke a method that creates visit object 642 and stores connection information in visit object state 642. Visit object 642, in turn, invokes a method in matching code 653 to initiate contact between member 306 and the owner of the technology. By demonstrating interest in a technology, member 306 causes matching code 653 to send a request to initiate direct contact with the owner of the technology. If the owner of the technology declines the request, matching code 653 generates a rejection response and sends the response to member 306 to end the deal. If the owner of the technology accepts the request, however, matching code 653 generates an “OK” response, digitally notarizes the response, sends the response to member 306, and waits for a confirmation message from member 306. When member 306 responds with a digitally notarized confirmation message, the parties can access the secure collaboration area associated with the owner of the technology. Matching code 653 stores the data retrieved from member 306 in matching data state 663 and database 340. FIG. 7C describes, in greater detail, the process that matching code 653 follows to initiate direct contact between member 306 and the owner of a technology. Even though FIG. 6 depicts central processor 616 as controlling matching code 653, it is to be understood that the function performed by matching code 653 can be distributed to a separate system configured similarly to technology exchange system 110.

When the two members agree to direct contact in a secure collaboration area, secure home page 500 sends a message to TCP/IP interface 622 to invoke a method that creates visit object 642 and stores connection information in visit object state 642. Visit object 642, in turn, invokes a method in exchange code 654 to determine whether the parties agree to disclose confidential information. After the parties agree to an initial direct contact, member 306 evaluates the project profile in the secure collaboration area. Exchange code 654 has three mechanisms to help advance the evaluation. First, the parties can agree to participate in a nonexclusive review of the technology by entering into a due diligence agreement. Second, the parties can agree to participate in an exclusive review of the technology by entering into a right of first refusal agreement. Third, the parties can agree to negotiate the terms of a transaction agreement. Each of these three mechanisms may optionally be followed-up with a letter of intent binding the parties. At any evaluation decision point, either party can decide to cease exchanging information and force exchange code 654 to update the project profile and terminates the collaboration between the parties. Exchange code 654 stores the data retrieved from member 306 in exchange data state 664 and database 340. FIG. 7D describes, in greater detail, the process that exchange code 653 follows to determine whether parties agree to disclose confidential information. Even though FIG. 6 depicts central processor 616 as controlling exchange code 654, it is to be understood that the function performed by exchange code 654 can be distributed to a separate system configured similarly to technology exchange system 110.

When member 306 needs to administer community web site 320 or project portal 330, either home page 323 or secure home page 500 send a message to TCP/IP interface 622 to invoke a method that creates visit object 642 and stores connection information in visit object state 642. Visit object 642, in turn, invokes a method in administration code 655 to provide member 306 with the tools to administer the account login or the secure collaboration area.

Administration code 655 stores the data retrieved from member 306 in administration data state 665 and database 340. Even though FIG. 6 depicts central processor 616 as controlling administration code 655, it is to be understood that the function performed by administration code 655 can be distributed to a separate system configured similarly to technology exchange system 110.

FIG. 7A is a flow diagram of a process that registers member 306 with technology exchange system 110. The registration process begins with potential member 305 accessing member registration section 315 of pedestrian web site 310, providing information such as name, company affiliation, electronic mail address, and anonymous login name. Step 701 is realized when potential member 305 clicks the “submit” button on member registration section 315 to send the registration data to technology exchange system 110. Technology exchange system 110 stores the registration data in database 340 at step 702. Following completion of step 702, technology exchange system 110 analyzes the registration data to verify the qualifications of potential member 305 at step 703. In another embodiment, technology exchange system 110 performs step 703 on a periodic basis. At step 704, technology exchange system 110 determines whether potential member 305 satisfies the qualification criteria. If potential member 305 satisfies the qualification criteria, technology exchange system 110 creates an account for member 306 at step 706 and sends account login name and password to the electronic mail address specified in the registration data at step 707. If potential member 305 does not satisfy the qualification criteria, technology exchange system 110 sends a rejection notification to the electronic mail address specified in the registration data at step 705. Step 709 examines the type of response received by the potential member 305 at step 708. If the response is a rejection, potential member 305 cannot enter technology exchange system 110. If the response is not a rejection, potential member 305 proceeds to the process in FIG. 7B.

FIG. 7B is a flow diagram of a process that creates a profile in technology exchange system 110 for member 306. Technology exchange system 110 requires each member 306 to create a member profile that includes personal and company information describing the member. If technology exchange system 110 determines at step 710 that a profile does not exist for member 306, step 711 requires member 306 to submit a profile. Once a profile exists for member 306, step 712 determines if the active role for member 306 is that of a Supplier. If member 306 is a Supplier, step 713 determines if the Supplier wants to create a project profile that includes non-confidential and confidential information describing a project and associates that project with the Supplier. At step 714, the Supplier submits the project profile to technology exchange system 110. Steps 713 and 714 are repeated, as necessary, to create additional project profiles. If member 306 is not a Supplier (see step 712) or the Supplier does not need to create any more project profiles (see step 713), step 715 determines if member 306 wants to create a need profile that includes search characteristics. If member 306 wants to create a need profile, member 306 specifies the search characteristics and categorizes each characteristics as either required (i.e., “must have”) or optional (i.e., “nice to have”) at step 716. At step 717, member 306 submits the need profile to technology exchange system 110. If member 306 does not want to create a need profile (see step 715) or submitted a need profile (see step 717), member 306 can browse the public information displayed in a list of member profiles or a list of project profiles at step 718. As an alternative to browsing the directory listing (see step 718), at step 719 member 306 can request that the technology exchange and collaboration system periodically examine the member and project profiles and notifies member 306 by electronic mail when a new profile or interesting event occurs. If member 306 discovers a profile while browsing the public information that piques his interest or if a comparison of the portfolios in technology exchange system 110 indicates that two members share common search characteristics (i.e., the members are a good match), the process proceeds to FIG. 7C.

FIG. 7C is a flow diagram of a process that automates the evaluation of a project such as the development of an innovative technology or intellectual property asset in technology exchange system 110. At step 720, member 306 initiates direct contact by requesting a more thorough description of the project from the Supplier. FIG. 7D describes the flow of step 720 in greater detail. At step 722, member 306 decides whether the evaluation of the more detailed description at step 721 warrants further evaluation. If it does not warrant further evaluation, step 723 updates the project profile to indicate that evaluation by member 306 has ceased. If it warrants further evaluation, step 724 determines if member 306 wants to conduct a non-exclusive review of the project. If member 306 desires a non-exclusive review of the project, member 306 and the Supplier enter into a due diligence agreement at step 725. FIG. 7E describes the flow of step 725 in greater detail. Member 306 can optionally send a letter of intent to the Supplier at step 726. FIG. 7G describes the flow of step 726 in greater detail. After step 726 or if member 306 does not desire a non-exclusive review of the project (see step 724), step 727 determines if member 306 wants to conduct an exclusive review of the project. If member 306 desires an exclusive review of the project, member 306 and the Supplier enter into a right of first refusal agreement at step 728. FIG. 7F describes the flow of step 728 in greater detail. Member 306 can optionally send a letter of intent to the Supplier at step 729. FIG. 7G describes the flow of step 729 in greater detail. After step 729 or if member 306 does not desire an exclusive review of the project (see step 727), step 730 determines if member 306 wants to request a transaction with the Supplier. If member 306 requests a transaction, member 306 and the Supplier negotiate the terms of the transaction at step 731. Technology exchange system 110 does not automate the negotiation of the terms, but does provide collaborative tools that facilitate communication between member 306 and the Supplier. After step 731 or if member 306 is not requesting a transaction, step 732 updates the project profile to indicate that evaluation by member 306 has ceased.

FIG. 7D is a flow diagram of a process that initiates direct contact between member 306 and a Supplier by requesting a more thorough description of the project from the Supplier. At step 740, member 306 sends a request for direct contact to the Supplier. After receiving the request from member 306, the Supplier decides if he accepts the request at step 741. If the Supplier decides to accept the request from member 306, he sends a digitally notarized “OK” response to member 306 at step 742 and member 306 responds with a digitally notarized “OK” message at step 743. If the Supplier declines the request from member 306, he decides at step 744 if he wants to revise the request. If member 306 decides to revise the request, he sends a counter proposal to the Supplier at step 745 and the process repeats from step 741. If member 306 decides not to revise the request, step 746 sends a rejection response to the Supplier and step 747 updates the project profile to indicate that evaluation by member 306 has ceased.

FIG. 7E is a flow diagram of a process that member 306 and the Supplier use to enter into a due diligence agreement. At step 750, the member 306 sends a request for due diligence to the Supplier. After receiving the request from member 306, the Supplier decides if he accepts the request at step 751. If the Supplier decides to accept the request from member 306, he sends a digitally notarized “OK” response to member 306 at step 752. Member 306 responds with a digitally notarized “OK” message at step 753. If the Supplier declines the request from member 306, he decides at step 754 if he wants to revise the request. If member 306 decides to revise the request, he sends a counter proposal to the Supplier at step 755 and the process repeats from step 751. If member 306 decides not to revise the request, step 756 sends a rejection response to the Supplier and step 757 updates the project profile to indicate that evaluation by member 306 has ceased.

FIG. 7F is a flow diagram of a process that member 306 and the Supplier use to enter into a right of first refusal agreement. At step 760, member 306 sends a request for a right of first refusal to the Supplier. After receiving the request from member 306, the Supplier decides if he accepts the request at step 761. If the Supplier decides to accept the request from member 306, he sends a digitally notarized “OK” response to member 306 at step 762. Member 306 responds with a digitally notarized “OK” message at step 763. If the Supplier declines the request from member 306, he decides at step 764 if he wants to revise the request. If member 306 decides to revise the request, he sends a counter proposal to the Supplier at step 765 and the process repeats from step 761. If member 306 decides not to revise the request, step 766 sends a rejection response to the Supplier and step 767 updates the project profile to indicate that evaluation by member 306 has ceased.

FIG. 7G is a flow diagram of a process that member 306 and the Supplier use to execute a letter of intent. At step 770, member 306 sends a request for a letter of intent to the Supplier. After receiving the request from member 306, the Supplier decides if he accepts the request at step 771. If the Supplier decides to accept the request from member 306, he sends a digitally notarized “OK” response to member 306 at step 772. Member 306 responds with a digitally notarized “OK” message at step 773. If the Supplier declines the request from member 306, he decides at step 774 if he wants to revise the request. If member 306 decides to revise the request, he sends a counter proposal to the Supplier at step 775 and the process repeats from step 771. If member 306 decides not to revise the request, step 776 sends a rejection response to the Supplier and step 777 updates the project profile to indicate that evaluation by member 306 has ceased.

Although the embodiments disclosed in the method, system, and apparatus for technology exchange and collaboration describe a fully functioning system, it is to be understood that other equivalent embodiments exist. Since numerous modifications and variations will occur to those who review this disclosure, the technology exchange and collaboration system is not limited to the exact construction and operation illustrated and described herein. Accordingly, this disclosure intends all suitable modifications and equivalents to fall within the scope of the claims.

I claim:

1. A method for technology exchange and collaboration comprising:
storing a first profile associated with a first member, a second profile associated with a second member, and a project profile associated with the first member;
comparing the first profile and the second profile to identify at least one common characteristic; and
permitting an exchange between the first member and the second member if the comparison identifies said at least one common characteristic.

2. The method of claim 1, wherein the first profile and the second profile include a description segment and a search segment.

3. The method of claim 2, wherein the description segment includes at least one public characteristic and at least one private characteristic.

4. The method of claim 2, wherein the search segment includes at least one required element and at least one optional element.

5. The method of claim 1, wherein the first profile and the second profile include at least one characteristic, and wherein comparing the first profile and the second profile further comprises:
considering a degree of importance associated with each characteristic.

6. The method of claim 1, wherein comparing the first profile and the second profile further comprises:
displaying a member profile list that includes the first profile and the second profile.

7. The method of claim 1, wherein comparing the first profile and the second profile further comprises:
displaying a project profile list that includes the project profile.

8. The method of claim 1, wherein the exchange involves an intellectual property asset.

9. The method of claim 1, wherein the first member and the second member accede to the exchange.

10. The method of claim 9, wherein the first member and the second member accede to a standardized non-disclosure agreement.

11. The method of claim 1, wherein permitting the exchange further comprises:
monitoring the exchange.

12. The method of claim 1, wherein permitting the exchange further comprises:
automating the exchange.

13. The method of claim 1, wherein the exchange includes the first member and the second member acceding to a standardized due diligence agreement.

14. The method of claim 1, wherein the exchange includes the first member and the second member acceding to a standardized right of first refusal agreement.

15. The method of claim 1, wherein the exchange includes the first member and the second member acceding to a standardized letter of intent.

16. The method of claim 1, wherein the exchange includes the first member and the second member negotiating the terms of a transaction.

17. The method of claim 1, wherein permitting the exchange further comprises:
certifying the exchange.

18. The method of claim 1, wherein the exchange is conducted in a secure storage area within the system that only the first entity and the second entity can access.

19. The method of claim 1, wherein the exchange is conducted in a storage area outside the system and a secure link encrypts data communications between the first entity, the second entity, and the system.

20. The method of claim 1, further comprising:
creating an account for a member of the system.

21. The method of claim 20, wherein creating the account further comprises:
verifying whether a potential member satisfies at least one criterion.

22. A computer device facilitating technology exchange and collaboration comprising:
a memory device; and
a processor disposed in communication with the memory device, the processor configured to:
store a first profile associated with a first member, a second profile associated with a second member, and a project profile associated with the first member;
compare the first profile and the second profile to identify at least one common characteristic; and
permit an exchange between the first member and the second member if the comparison identifies said at least one common characteristic.

23. The computer device of claim 22, wherein the first profile and the second profile include a description segment and a search segment.

24. The computer device of claim 23, wherein the description segment includes at least one public characteristic and at least one private characteristic.

25. The computer device of claim 23, wherein the search segment includes at least one required element and at least one optional element.

26. The computer device of claim 22, wherein the first profile and the second profile include at least one characteristic, and wherein the processor is further configured to:
consider a degree of importance associated with each characteristic.

27. The computer device of claim 22, wherein the processor is further configured to:
display a member profile list that includes the first profile and the second profile.

28. The computer device of claim 22, wherein the processor is further configured to:
display a project profile list that includes the project profile.

29. The computer device of claim 22, wherein the exchange involves an intellectual property asset.

30. The computer device of claim 22, wherein the first member and the second member accede to the exchange.

31. The computer device of claim 30, wherein the first member and the second member accede to a standardized non-disclosure agreement.

32. The computer device of claim 22, wherein the processor is further configured to:
monitor the exchange.

33. The computer device of claim 22, wherein the processor is further configured to:
automate the exchange.

34. The computer device of claim 22, wherein the exchange includes the first member and the second member acceding to a standardized due diligence agreement.

35. The computer device of claim 22, wherein the exchange includes the first member and the second member acceding to a standardized right of first refusal agreement.

36. The computer device of claim 22, wherein the exchange includes the first member and the second member acceding to a standardized letter of intent.

37. The computer device of claim 22, wherein the exchange includes the first member and the second member negotiating the terms of a transaction.

38. The computer device of claim 22, wherein the processor is further configured to:
certify the exchange.

39. The computer device of claim 22, wherein the exchange is conducted in a secure storage area within the system that only the first entity and the second entity can access.

40. The computer device of claim 22, wherein the exchange is conducted in a storage area outside the system and a secure link encrypts data communications between the first entity, the second entity, and the system.

41. The computer device of claim 22, wherein the processor is further configured to:
create an account for a member of the system.

42. The computer device of claim 41, wherein the processor is further configured to:
verify whether a potential member satisfies at least one criterion.

43. A computer readable medium comprising:
code for storing a first profile associated with a first member, a second profile associated with a second member, and a project profile associated with the first member;
code for comparing the first profile and the second profile to identify at least one common characteristic; and
code for permitting an exchange between the first member and the second member if the comparison identifies said at least one common characteristic.

44. The computer readable medium of claim 43, wherein the first profile and the second profile include a description segment and a search segment.

45. The computer readable medium of claim 44, wherein the description segment includes at least one public characteristic and at least one private characteristic.

46. The computer readable medium of claim 44, wherein the search segment includes at least one required element and at least one optional element.

47. The computer readable medium of claim 43, wherein the first profile and the second profile include at least one characteristic, and wherein the code for comparing the first profile and the second profile further comprises:
code for considering a degree of importance associated with each characteristic.

48. The computer readable medium of claim 43, wherein the code for comparing the first profile and the second profile further comprises:
code for displaying a member profile list that includes the first profile and the second profile.

49. The computer readable medium of claim 43, wherein the code for comparing the first profile and the second profile further comprises:
code for displaying a project profile list that includes the project profile.

50. The computer readable medium of claim 43, wherein the exchange involves an intellectual property asset.

51. The computer readable medium of claim 43, wherein the first member and the second member accede to the exchange.

52. The computer readable medium of claim 51, wherein the first member and the second member accede to a standardized non-disclosure agreement.

53. The computer readable medium of claim 43, wherein the code for permitting the exchange further comprises:
code for monitoring the exchange.

54. The computer readable medium of claim 43, wherein the code for permitting the exchange further comprises:
code for automating the exchange.

55. The computer readable medium of claim 43, wherein the exchange includes the first member and the second member acceding to a standardized due diligence agreement.

56. The computer readable medium of claim 43, wherein the exchange includes the first member and the second member acceding to a standardized right of first refusal agreement.

57. The computer readable medium of claim 43, wherein the exchange includes the first member and the second member acceding to a standardized letter of intent.

58. The computer readable medium of claim 43, wherein the exchange includes the first member and the second member negotiating the terms of a transaction.

59. The computer readable medium of claim 43, wherein the code for permitting the exchange further comprises:
code for certifying the exchange.

60. The computer readable medium of claim 43, wherein the exchange is conducted in a secure storage area within the system that only the first entity and the second entity can access.

61. The computer readable medium of claim 43, wherein the exchange is conducted in a storage area outside the system and a secure link encrypts data communications between the first entity, the second entity, and the system.

62. The computer readable medium of claim 43, further comprising:
code for creating an account for a member of the system.

63. The computer readable medium of claim 62, wherein the code for creating an account further comprises:
code for verifying if a potential member satisfies at least one criterion.
